(19) United States
(12) Patent Application Publication
(10) Pub. No.: US 2007/0124483 A1
(43) Pub. Date: May 31, 2007

(54) System and method for high QoS digital content-based services

(76) Inventors: David Marples, Mansfield (GB); Stanley Moyer, Mendham, NJ (US)

Correspondence Address: TELCORDIA TECHNOLOGIES, INC., ONE TELCORDIA DRIVE 5G116, PISCATAWAY, NJ, 08854-4157, US

(21) Appl. No.: 11/591,338

(22) Filed: Nov. 1, 2006

Related U.S. Application Data
(60) Provisional application No. 60/732,016, filed on Nov. 1, 2005.

(51) Int. Cl. G06F 15/16

(52) U.S. Cl. 709/228

(57) ABSTRACT

A digital content mediator (“DCM”) communicates with a network resource controller/manager (NRM) to allocate the appropriate network resources for a digital content transfer. A DCM client provides a signal to the DCM requesting the desired digital content transaction. The DCM checks a content information database to see if the content transfer is allowed. If the transfer is allowed, the DCM then extracts content transfer information from the content information database that describes network resource characteristics for transfer of that content. The DCM then formulates a request to the Network Resorce Manager containing the source and destination endpoint information in addition to the network resource characteristics of the content to be transferred. The Network Resource Manager (NRM) then makes the appropriate resource allocations. If the request succeeds, the DCM “approves” the request and signals to the client that the transfer process can continue. At the end of the transfer process, after the DCM has verified that the destination user has received the desired digital content, the DCM provides a “signal” to the NRM requesting that the reserved network resources be de-allocated.

### CROSS REFERENCE TO RELATED APPLICATION

This application claims the benefit of U.S. Provisional Patent Application No. 60/732,016, filed Nov. 1, 2005, the disclosure of which is hereby incorporated herein by reference.

### FIELD OF THE INVENTION

The present invention relates generally to the field of content distribution in a network and specifically to the control and allocation of network resources in order to support high quality of service digital content transaction-type services.

### BACKGROUND OF THE INVENTION

As telecommunications carriers evolve toward becoming broadband communications service providers, an opportunity exists for them to become central to the broadband provision of content. Carriers can provide “smart pipes” via a broadband service network which provides efficient and quality operations for both communication and content distribution. The infrastructure can also support micro-charging for content just as carriers perform micro-billing for communications today. In this type of environment the ability to control the quality of service (QoS) becomes important as purchasers of content will want to be assured of access to such content.

The QoS problem has typically been solved be the end-user first establishing a high QoS “connection” in any number of ways to the source of the desired digital content thereby obtaining the digital content in a controlled manner from a centralized content server or through a peer-to-peer content sharing protocol. For example, the end-user may establish a point-to-point virtual private network (“VPN”) or use a session establishment protocol such as the Session Initiation Protocol (“SIP”).

For the end-user to establish a high QoS connection to the digital content source, the end-user is required to know (a priori) where the content is located. Often time that is not possible (e.g., due to a storefront not providing the location of its servers or not knowing where content is located in a peer-to-peer network—at least ahead of time).

### BRIEF SUMMARY OF THE INVENTION

The present invention sets forth a system and method for coupling a digital content mediator (DCM) with a network resource controller/manager (NRM) in order to enable end-users to easily and seamlessly retrieve digital content with high QoS.

A DCM client provides a signal to the DCM requesting the desired digital content transaction. The DCM checks a content information database to see if the content transfer is allowed. If the transfer is allowed, the DCM then extracts content transfer information from the content information database that describes network resource characteristics for transfer of that content. The DCM then formulates a request to the Network Resorce Manager containing the source and destination endpoint information in addition to the network resource characteristics of the content to be transferred. The Network Resource Manager (NRM) then makes the appropriate resource allocations. If the request succeeds, the DCM “approves” the request and signals to the client that the transfer process can continue. At the end of the transfer process, after the DCM has verified that the destination user has received the desired digital content, the DCM provides a “signal” to the NRM requesting that the reserved network resources be de-allocated.

The invention will be more clearly understood when the following description is read in conjunction with the accompanying drawings.

### BRIEF DESCRIPTION OF THE DRAWINGS

FIG. 1 shows schematically an architecture for the provision of high QoS content services.

FIG. 2 is a flow chart of the method for transferring digital content at a high QoS.

### DETAILED DESCRIPTION

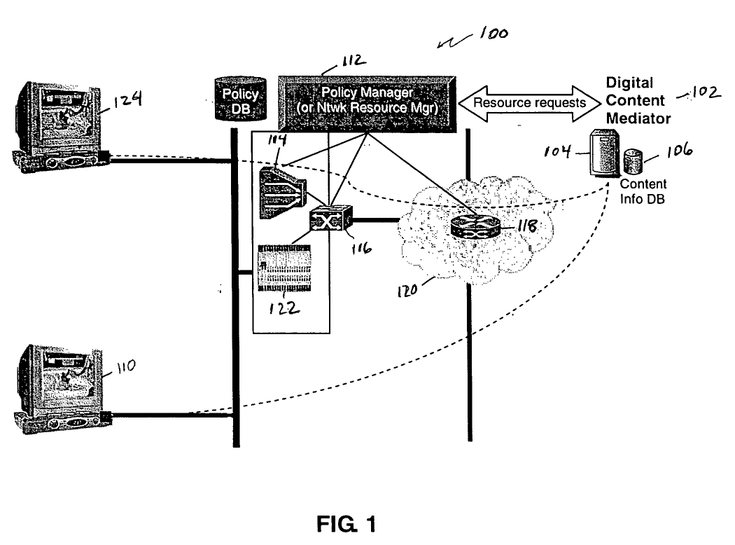

FIG. 1 shows an example of an architecture 100 for providing high QoS digital content services. The present invention extends the use of a Digital Content Mediator (DCM) to communicate with a network resource controller/manager (NRM) in order to allocate the appropriate network resources (access, core, and/or home) for a digital content transfer, i.e., reserve the necessary bandwdith and/or minimize delay or jitter. A Digital Content Mediator is described and illustrated, for example, in U.S. Patent Application Publication No. 2006/0173783, published on Aug. 3, 2006, entitled “System and Method for Authorized Digital Content Distribution”, which is incorporated herein by reference. A DCM comprises a server-based component 104 and a content information database 106. In addition, there is corresponding client code that resides at the client/end user e.g., in devices or embedded in applications. While the invention will be described in conjunction with the use of a DCM, it will be apparent to those skilled in the art that other types of content mediation technology devices and/or softwear may be used in its place.

In FIG. 1, a first DCM client 110 signals to the DCM 102 a request for the desired digital content from the content information database 106. The DCM server 104 checks the content information database 106 to determine if the requested content transfer is allowed according to a predetermined set of rules. If the transfer is allowed, the DCM server 104 extracts the content transfer information from the content information database 106 that describes network resource characteristics for that content e.g., bandwidth, delay, and jitter. The DCM 102 then formulates a request to a Network Resource Manager 112 (e.g., CableLabs PacketCable Policy Manager) that includes the source and destination endpoint information, in addition to the network resource characteristics of the content to be transferred.

The Network Resource Manager (NRM) 112 then makes the appropriate resource allocations for the access network manager 114, access network switches 116, and service provider routers 118 located in the service provider's network 120. It is possible that the resource allocation could fail in which case the NRM 112 indicates this status to the DCM 112. The DCM may then decide to deny the transfer request or continue the transfer but with a lower QoS. If the allocation succeeds and perhaps, even if the allocation fails, the DCM “approves” the transfer request and signals to the clients 110 and 124 that the transfer process can continue. At the end of the transfer process, after the DCM has verified that the destination user/client has received the desired digital content, the DCM sends a “signal” to the NRM 112 requesting that the reserved network resources be de-allocated.

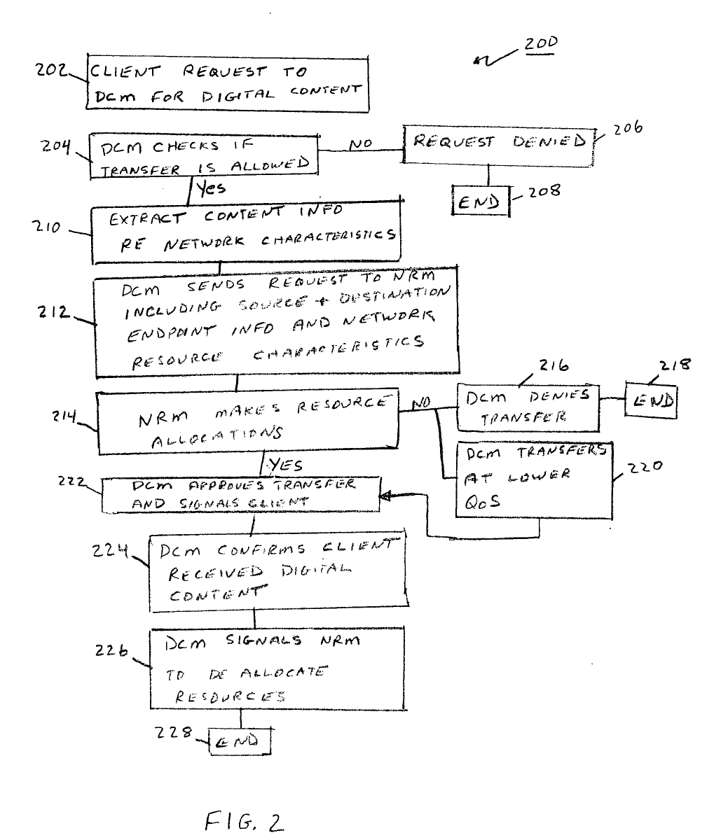

FIG. 2 is a flow chart of the method for transferring digital content at a high QoS 200. In step 202 a client sends a request to the DCM for digital content. The DCM checks if the transfer is allowed according to predetermined rules in step 204. If the request is denied in step 206, the process of content transfer ends in step 208. If the transfer is permitted, information is extracted from the content information database regarding network characteristics for transferring the requested digital content in step 210. The DCM in step 212 sends a request to the NRM including the source and destination information for the transfer of the digital content along with the network resources characteristics. The client/end-user does not need a priori knowledge of the location of the content when making the request for the digital content. The source information is located in the content information database. In response to the request from the DCM, the NRM allocates the necessary resources for the transfer in step 214. If the NRM is unable to allocate the necessary resources, the DCM may deny the transfer in step 216 and the process ends 218. Alternatively, the DCM may decide to transfer the content at a lower QoS in step 220. The DCM approves the transfer of the digital content and signals the client in step 222. After the transfer at either the high QoS or lower QoS is confirmed in step 224, the DCM sends a signal to the NRM to de-allocate the network resources 226 and the process ends 228.

The invention enables end users to transfer digital content with a high QoS network without having to manually establish the high QoS connection or having to know the location of the digital content a priori. The fact that the DCM is “aware” of the beginning and end destinations of the content transfers and has a mechanism for associating network characteristics with a content item in the content information database, results in the method being applicable to many alternative content transfer mechanisms.

While there has been described and illustrated a system and method for using a network resource manager to allocate resources in response to a request for content to a digital content mediator from a client, it will be apparent to those skilled in the art that variations and modifications are possible without deviating from the broad teachings and spirit of the present invention which shall be limited solely by the scope of the claims appended hereto.

What is claimed is:

1. A system for using a network resource manager to allocate network resources in response to a request for content transfer to a digital content mediator (DCM) from a client comprising:
means for receiving a request from a client at the DCM requesting a digital content transfer;
means for checking a content information database included with the DCM to see if the content transfer is allowed;
if the transfer is allowed, extracting at the DCM the content transfer information from the content information database;
means for formulating at the DCM a request to a Network Resource Manager (NRM) containing the source and destination endpoint information for the content transfer and the network resource characteristics of the content to be transferred;
means associated with the NRM for allocating the appropriate network resources; and
if allocation succeeds then approving the transfer request at the DCM and signaling to the client that the transfer of content can begin.

2. A system for using a network resource manager to allocate network resources in response to a request for content transfer to a digital content mediator (DCM) from a client comprising:
means for receiving a request from a client at the DCM requesting a digital content transfer;
means for checking a content information database included with the DCM to see if the content transfer is allowed;
if the transfer is allowed, extracting at the DCM the content transfer information from the content information database;
means for formulating at the DCM a request to a Network Resource Manager (NRM) containing the source and destination endpoint information for the content transfer and the network resource characteristics of the content to be transferred;
means associated with the NRM for allocating the appropriate network resources; and
if allocation fails then approving the transfer request at the DCM at a lower QoS and signaling to the client that the transfer of content can begin.

3. A method for using a network resource manager (NRM) to allocate network resources in response to a request for content from a digital content mediator (DCM) including a content information database comprising the steps of:
receiving a request from a client at the DCM for a digital content transfer;
checking at the DCM content information database to see if the content transfer is allowed;
if the transfer is allowed, extracting at the DCM content transfer information from the content information database;
formulating at the DCM a request to the NRM containing the source and destination endpoint information for the transfer in addition to the network resource characteristics of the content to be transferred;
allocating the appropriate network resources at the NRM; and
if allocation succeeds then approving the request at the DCM and signaling to the client that the transfer of content can begin.

4. The method as set forth in claim 3 further comprising the step of de-allocating the network resources at the NRM in response to a signal received from the DCM that the client has received the content.

5. A method for using a network resource manager (NRM) to allocate network resources in response to a request for content from a digital content mediator (DCM) including a content information database comprising the steps of:
receiving a request from a client at the DCM for a digital content transfer;
checking at the DCM content information database to see if the content transfer is allowed;
if the transfer is allowed, extracting at the DCM content transfer information from the content information database;
formulating at the DCM a request to the NRM containing the source and destination endpoint information for the transfer in addition to the network resource characteristics of the content to be transferred;
allocating the appropriate network resources at the NRM; and
if allocation fails then approving the transfer request at the DCM at a lower QoS and signaling to the client that the transfer of content can begin.

6. The method as set forth in claim 5 further comprising the step of de-allocating the network resources at the NRM in response to a signal received from the DCM that the client has received the content.
